(19) United States
(12) Patent Application Publication
(10) Pub. No.: US 2013/0234379 A1
(43) Pub. Date: Sep. 12, 2013

(54) ADVANCED TRIPLE PISTON DAMPER

(71) Applicant: Pinyo PANICHGASEM, Bangkok (TH)

(72) Inventor: Pinyo PANICHGASEM, Bangkok (TH)

(73) Assignee: Y.S.S. (THAILAND) CO., LTD., Samutprakarn (TH)

(21) Appl. No.: 13/870,188

(22) Filed: Apr. 25, 2013

Related U.S. Application Data
(63) Continuation-in-part of application No. 12/533,663, filed on Jul. 31, 2009, now abandoned.

(30) Foreign Application Priority Data
Jan. 19, 2009 (TH) 0901000202

(51) Int. Cl. B60G 15/06

(52) U.S. Cl. CPC B60G 15/061
USPC 267/226

(57) ABSTRACT

The advanced triple piston damper having three pistons working together as described herein is for use with a motorcycle to dampen an impact. The advanced triple piston damper can work at three different stroking speeds, i.e., slow, intermediate, and fast. The advanced triple piston damper has a better response to dampening an impact than the conventional nitrogen gas systems and can avoid the gas leakage problems associated with such systems.

The present application is a continuation-in-part of U.S. Utility application Ser. No. 12/533,663, filed Jul. 31, 2009, which is incorporated herein by reference in its entirety for all purposes.

### FILED OF THE INVENTION

The present invention relates to a shock absorber, and in particular, to an advanced triple piston damper that can be for use with a motorcycle.

### BACKGROUND

Conventional pull-type piston dampers disclosed in the prior art generally have arrangements of only one or two pistons. The first piston of these dampers acts against the fluid pressure when the piston rod moves while the second piston acts against the fluid pressure build up generated from the first piston in the cylinder. The second piston can move along the direction of force of the piston rod and from nitrogen gas filled in the cylinder. These piston dampers suffer from not being fully responsive to damping an impact and routinely have gas or fluid leaks that reduce the damping ability of the pistons. Thus, there is a need to provide a pull-type piston damper system for a motorcycle which can eliminate or partially avoid the drawbacks of the prior art.

The advanced triple piston damper (ATPD) of the present invention relates to a pull-type piston damper of a shock absorber of a motorcycle. The damper of the pull type piston damper system is designed to have three pistons capable of working at three stroking speeds, i.e., slow, intermediate, and fast. The ATPD provides a system of shock absorbers having three pistons that are capable of having a better response to a working requirement than the other conventional systems. The shock absorber has an advantage over the nitrogen gas filled systems in that the gas leaking problem is avoided.

### BRIEF SUMMARY

A damper having an internal mechanism. The internal mechanism including a first piston that acts or moves against fluid pressure when a piston rod moves in and out in the damper. The first piston can include a shaft, bush valve, a compression shim, a moveable piston, a piston ring, a rebound shim, a washer and a valve nut. The moveable piston can contain through holes or apertures for allowing fluid to pass through the moveable piston. The internal mechanism can further include a stationary second piston that does not move but permits fluid to pass through it by use of a compression vale having one or more through holes or apertures. The second further acts against fluid pressure using one or more shims located above the compression valve, the one or more shims restricting fluid flow through the one or more through holes in the compression valve. The second piston can include a socket hand cap, shim washer, a compression shim, a compression valve, an O-ring, a rebound shim, a C-snap external clamp and spring conic. The internal mechanism can further include a third piston. The moveable third piston acts against fluid pressure using the compressive force of a spring installed inside the body of the damper, the spring being located below the freely moveable third piston. The third piston can include a screw, a piston ring, a moveable piston, an O-ring and a spring. The third piston preferably does not permit fluid to flow through it to the spring compartment.

An advanced triple piston damper having three pistons, a first piston, a second piston and a third piston. All three pistons work in relation to one another wherein the first and third pistons are moveable and the second piston is stationary. The advanced triple piston damper is designed to have a damper system and a pull system which allows all three pistons to work at low, intermediate and high stroke speed. The first piston acts against fluid pressure caused by a piston rod moving in and out wherein the first piston is connected to the piston rod. The second piston acts against fluid pressure generated from the moving of the first piston, wherein the second piston remains in place. The second piston has a compression shim located on top of a compression valve and a rebound shim located on the bottom of the compression valve. The third piston acts against fluid pressure using the pressure generated from the force of a spring installed below the third piston instead of using nitrogen gas. As the piston rod moves in and out, the third piston moves in the same direction as the piston rod and the third piston having fluid resistance acting on top of the third piston and spring force resistance acting on the bottom of the third piston.

### BRIEF DESCRIPTION OF THE DRAWINGS

The following figures illustrate various aspects of one or more embodiments of the present invention, but are not intended to limit the present invention to the embodiments shown.

FIG. 1A shows a side view of an advanced triple piston damper.

FIG. 1B shows a cross-section view of the advanced triple piston damper of FIG. 1A.

FIG. 2 shows an exploded cross-section view of the first piston of the advanced triple piston damper of FIGS. 1A and 1B. In a non-exploded view, the components of FIG. 2 would be in contact with another as arranged.

FIG. 3 shows an exploded cross-section view of the second piston of the advanced triple piston damper of FIGS. 1A and 1B. In a non-exploded view, the components of FIG. 3 would be in contact with another as arranged.

FIG. 4 shows an exploded cross-section view of the third piston of the advanced triple piston damper of FIGS. 1A and 1B. In a non-exploded view, the components of FIG. 4 would be in contact with another as arranged.

### DETAILED DESCRIPTION

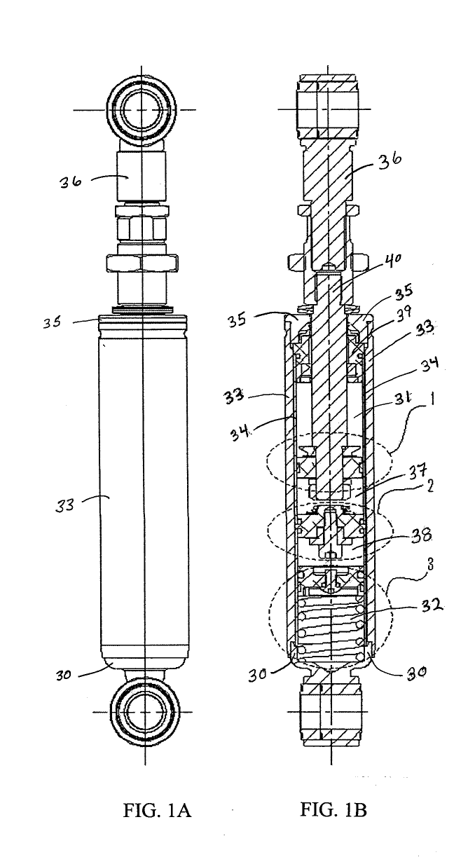

FIG. 1A shows an outer side view of an advanced triple piston damper. The damper has a piston rod 36 that moves in and out of the damper. Capping the internal mechanism of the damper is a bottom fitting 30 and a top fitting 35. An outer tube 33 houses the internal mechanism as described below.

FIG. 1B shows the advanced triple piston damper having an internal mechanism including three pistons. The three pistons are arranged in series with the first piston 1 on top and being connected to a piston rod 36, the second piston 2 being positioned between the first piston 1 and the third piston 3, and the third piston 3 being on the bottom below the second piston 2. The three pistons work in relation to one another to dampen an impact by acting against fluid pressure in the damper. The three pistons and fluid are housed in a cylinder body. The cylinder body can include an inner tube 34 and an outer tube 33. The outer tube 33 can surround the inner tube 34 such that the outer tube 33 is in direct contact with the inner tube 34 along the entire length of the inner tube. As shown, the outer tube does not contact the piston rod area or any internal components of the mechanism, such as the shaft connected to the piston rod. Rather, the top fitting 35 provides a seal for the piston rod and shaft as the components move in and out. The outer tube and inner tube are preferably made of metal and possess rigid structural integrity.

Fluid, such as liquid or oil, can fill the open cavity of the inner tube 34 near and around the three pistons. The inner tube 34 is capped at both ends to provide a sealed compartment having four chambers. Fluid contained in the sealed compartment does not leak out or contact the outer tube 33. Each chamber can be filled with fluid. At the top, the inner tube 34 has top ring seal 39 having an opening for permitting the shaft 40 of the first piston 1 to move in and out. The first piston 1, top ring seal 39 and inner tube 34 create a first fluid chamber 31. A top fitting is in contact and located above the top ring seal. A second fluid chamber 37 is formed between the first piston 1, second piston 2 and the inner tube 34. A third fluid chamber 38 is formed between the second piston 2, third piston 3 and the inner tube 34. A fourth chamber 32 is located below the third piston 3 where the inner tube 34 is capped by a bottom fitting 30. The fourth chamber 32 is preferably not filled with liquid but rather contains a spring for creating resistance force that the third piston uses to dampen an impact to the absorber. The fourth chamber 32 is preferably not pressurized, such as with nitrogen gas, for dampening purposes. The fourth chamber 32 preferably does not have an access port or valve for pressurizing the chamber.

The three pistons act against fluid pressure contained in the cylinder body. The first piston 1 acts against fluid pressure created by the piston rod 36 moving in and out. As the piston rod 36 moves in and the first piston 1 moves in the same direction, fluid passes from the second chamber 37 to the first chamber 31 through the first piston. The second piston 2 acts against fluid caused by the first piston 1 moving in the same direction with the piston rod. The second piston 2 remains in place and is stationary during the dampening process. As the first piston 1 moves, fluid from the third chamber 38 flows to the second chamber 37 through the second piston. The second piston acts against fluid pressure with the use of a compression shim and compression valve, which has through holes for permitting fluid flow through the chambers. The moveable third piston 3 acts against fluid pressure using the compressive force of a spring installed inside the body of the damper. The spring is located below the freely moveable third piston. Fluid from the third and fourth chambers does not flow through the third piston.

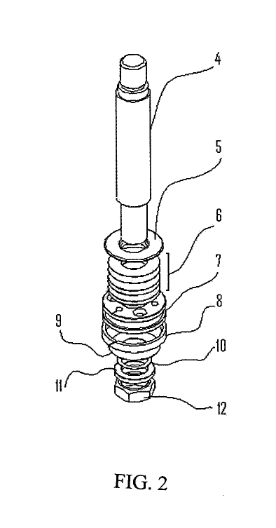

FIG. 2 shows an exploded cross-section view of the first piston 1 of the advanced triple piston damper. The first piston 1 can include a shaft 4. The top end of the shaft 4 is connected to the piston rod 36 and permits the first piston to move in the same direction as the piston rod. The bottom end portion of the shaft 4 has a bush valve 5 and a compression shim set 6 positioned around it. The bush valve and compression shim set have openings that accommodate the bottom end portion of the shaft. The bush valve 5 fits against a collar on the shaft 4 to prevent it from sliding upward on the shaft. A compression shim set 6 is located below the bush valve. The compression shim set can have one or more compression shims and, as shown, up to 6 compression shims is series, each can be in contact with one another. The compression shims, like the rebound shims, can be in the shape of rings as shown. The compression shims can be sized to overlay through holes or portions thereof in the piston 7 as desired. The bottom end portion of the shaft further extends through a center opening in piston 7 and the rebound shims 9, 10 and washer located below. The bottom end of the shaft 4 is capped with a valve nut to hold the components of the first piston in place.

The piston 7 has a piston ring 8 that surrounds a portion of the outer diameter surface of the piston 7. The piston 7 can have an outer notch that accommodates the piston ring 8. The outer diameter surface of the piston ring 8 and the remaining outer diameter surface of the piston 7 can be in contact with the inner tube 34. Below the piston 7, one or more rebound shims can be stacked and can be in contact with the bottom face of the piston 7. As shown, two rebound shims 9, 10 are located directly below the piston 7. A washer 11 and valve nut 12 can be located in series below the one or more rebound shims.

The piston 7 can permit fluid flow through the first piston for dampening purposes. The piston 7 can have one or more through holes for accommodating fluid flow through the piston. For example, the piston 7 can have 1, 2, 3, 4, 5, 6, 7, 8 or more through holes for fluid flow. The compression shims can control and restrict fluid flow to and from the first chamber 31 as desired. Rebound shims can control and restrict fluid flow to and from the second chamber 37 as desired. The compression shims and rebound shims can block portions of the outlets of the through holes located on the top and bottom surfaces of the piston. For instance, the compression and rebound shims can block 10 to 90 percent of the outlets of the through holes.

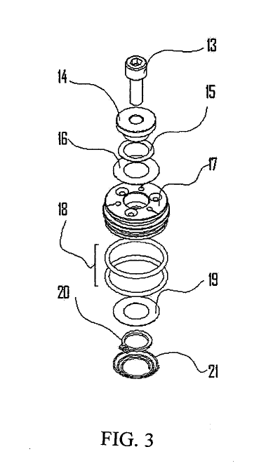

FIG. 3 shows an exploded cross-section view of the second piston 2 of the advanced triple piston damper. The second piston 2 can include a socket hand cap 13 having a cylinder portion for receiving a steel shim washer 14 that rests against a collar on the cap 13. Below the steel shim washer 14 can be one or more compression shims. As shown, two compression shims 15, 16 are located below the washer 14. The bottom most compression shim 16 rests against a compression valve 17. The compression shims, like the rebound shims, can be in the shape of rings as shown. The compression shims can be sized to overlay through holes or portions thereof in the compression valve 17 as desired. The compression valve 17 can have grooves along its outer diameter surface. O-rings 18 can be used to fill the grooves in the outer diameter surface of the compression valve 17 to create a seal with the inner tube 34 and separate the second and third fluid compartments. As shown, two O-rings can be used with the compression valve.

The compression valve 17 can permit fluid flow through the second piston for dampening purposes. The compression valve 17 can have one or more through holes for accommodating fluid flow through the valve. For example, the compression valve 17 can have 1, 2, 3, 4, 5, 6, 7, 8 or more through holes for fluid flow. The compression shims can control and restrict fluid flow to and from the second chamber 37 as desired. Rebound shims can control and restrict fluid flow to and from the third chamber 38 as desired. The compression shims and rebound shims can block portions of the outlets of the through holes located on the top and bottom surfaces of the compression valve. For instance, the compression and rebound shims can block 10 to 90 percent of the outlets of the through holes.

Below the compression valve 17, one or more rebound shims can be used. Rebound shim 19 directly contacts the compression valve. The second piston 2 can further include a C-snap external clamp 20 and a spring conic 21 at one end. The spring conic 21 can protect the second piston 2 from impact with another piston, such as the first or third piston in the internal mechanism. For example, the spring conic 21 can contact the valve nut of the first piston 1 to absorb impact between the two pistons or the screw of the third piston to avoid damage of an impact.

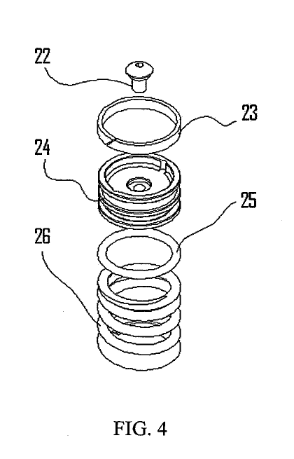

FIG. 4 shows an exploded cross-section view of the third piston 3 of the advanced triple piston damper. The third piston 3 can include a screw 22 for fitting into a freely moveable piston 24 having a center opening. The piston 24 has a piston ring 23 that surrounds a portion of the outer diameter surface of the piston 24. The piston 24 can have an outer notch that accommodates the piston ring 23. The outer diameter surface of the piston ring 23 and the remaining outer diameter surface of the piston 24 can be in contact with the inner tube 34 and separate the third and fourth fluid chambers. The piston 24 can further include a groove along its outer diameter surface. O-rings can be used to fill the grooves in the outer diameter surface of the piston 24 to create a seal with the inner tube 34. As shown, one O-ring 25 can be used with the piston 24. The piston 24, piston ring 23 and O-ring 25 seal the top surface of the fourth chamber 32.

A spring 26 is located below the piston 24. The spring 26 provides resistance force to the bottom of the third piston 3 for dampening purposes. The spring 26 is housed in the fourth chamber 32 and preferably does not contain pressurized gas. The piston 24 does not permit fluid to pass from the third chamber 38 to the fourth chamber 32 as the piston rod 36 moves in and out. As shown, the piston 24 does not have through holes for fluid flow. The center opening in the piston 24 is filled by screw 22.

While various embodiments in accordance with the present invention have been shown and described, it is understood that the invention is not limited thereto, and is susceptible to numerous changes and modifications as known to those skilled in the art. Therefore, this invention is not limited to the details shown and described herein, and includes all such changes and modification as encompassed by the scope of the appended claims.

What is claimed is:

1. A damper having an internal mechanism comprising:
a first piston that acts against fluid pressure when a piston rod moves in and out in the damper; the first piston comprising a shaft, bush valve, a compression shim, a moveable piston, a piston ring, a rebound shim, a washer and a valve nut;
a stationary second piston that acts against fluid pressure using shims located above the second piston, the second piston comprising a socket hand cap, shim washer, a compression shim, a compression valve, an O-ring, a rebound shim, a C-snap external clamp and spring conic;
a third piston that acts against fluid pressure using the compressive force of a spring installed inside the cylinder body of the damper and below the third piston, the third piston comprising a screw, a piston ring, a moveable piston, an O-ring and a spring.

2. The damper of claim 1, the cylinder body housing the first piston, second piston, third piston and fluid for generating fluid pressure as the piston rod moves in and out.

3. The damper of claim 2, the fluid being contained in the cylinder body.

4. The damper of claim 2, the cylinder body comprising an inner tube and an outer tube.

5. The damper of claim 4, the outer tube surrounding the inner tube, the outer tube being in direct contact with the inner tube along the entire length of the inner tube.

6. The damper of claim 5, the fluid being contained in the inner tube and the fluid not being in contact with the outer tube.

7. An advanced triple piston damper comprising a first piston, a second piston and a third piston wherein all three pistons work in relation to each other, the first piston acts against fluid pressure caused by a piston rod moving in and out; the second piston acts against fluid pressure generated from the moving of the first piston while the second piston remains in place, the second piston having a compression shim located above a compression valve and a rebound shim located below the compression valve; the third piston acts against fluid pressure using the pressure generated from the force of a spring installed below the third piston instead of using nitrogen gas; wherein when the piston rod moves in and out the third piston moves in the same direction as the piston rod and the third piston having fluid pressure resistance acting on top of the third piston and spring force resistance acting on the bottom of the third piston.

8. The advanced triple piston damper of claim 7, further comprising a cylinder body housing the first piston, the second piston, the third piston and fluid for generating fluid pressure as the piston rod moves in and out.

9. The advanced triple piston damper of claim 8, wherein the fluid does not leak from inside the cylinder body.

10. The advanced triple piston damper of claim 8, the cylinder body comprising an inner tube and an outer tube.

11. The advanced triple piston damper of claim 10, the outer tube surrounding the inner tube, the outer tube being direct contact with the inner tube along the entire length of the inner tube.

12. The advanced triple piston damper of claim 11, the fluid being contained in the inner tube such that the fluid does not leak from inside the inner tube to the outer tube.

13. The advanced triple piston damper of claim 10, the inner tube containing the fluid, the fluid not being in contact with the outer tube.

14. The advanced triple piston damper of claim 13, further comprising a compression shim located above the first piston and a rebound shim located below the first piston.

15. The advanced triple piston damper of claim 14, the compression shim located above the first piston being in direct contact with the first piston and the rebound shim located below the first piston being in direct contact with the first piston.

16. The advanced triple piston damper of claim 13, further comprising a spring conic located at an end of the second piston.

17. The advanced triple piston damper of claim 13, further comprising a second compression shim located above the compression valve of the second piston.

18. The advanced triple piston damper of claim 13, the compression valve having one or more through holes for permitting fluid flow through the compression valve.

19. The advanced triple piston damper of claim 13, the first piston having a piston having one or more through holes for permitting fluid flow through the piston.

20. The advanced triple piston damper of claim 19, the piston of the first piston having a compression shim located above the piston and a rebound shim located below the piston.
